(19) United States
(12) Patent Application Publication
(10) Pub. No.: US 2013/0329311 A1
(43) Pub. Date: Dec. 12, 2013

(54) Image Alignment Device for Tandem Optics (IAD-TO)

(71) Applicant: William Charles Frazer, Colleyville, TX (US)

(72) Inventor: William Charles Frazer, Colleyville, TX (US)

(21) Appl. No.: 13/908,528

(22) Filed: Jun. 3, 2013

Related U.S. Application Data
(60) Provisional application No. 61/656,247, filed on Jun. 6, 2012.

(51) Int. Cl. G02B 7/00

(52) U.S. Cl. CPC G02B 7/003
USPC 359/829; 359/811

(57) ABSTRACT

An image alignment device for tandem optics (IAD-TO) is disclosed which provides a standalone means for the operator to align and optimize the imagery produced by dissimilar optical devices to achieve overall system capability gain. The IAD-TO is inserted into the optical path between the optical devices when they are configured for in line use and provides the operator an on-demand capability to compensate for the inherent image shift between them, especially for those optical devices that provide no alignment adjustment mechanisms. Featuring interchangeable adaptor arms and quick action mount interfaces, the IAD-TO can be used with various types of optical devices and can be mounted to a variety of surfaces.

### RELATED U.S. APPLICATION DATA

Provisional application No. 61/656,247, filed Jun. 6, 2012

### REFERENCES CITED

U.S. Patent Documents

| | | | |
|---|---|---|---|
| 3,359,849 A | December 1967 | Friedman | 356/153 |
| 4,629,295 A | December 1986 | Vogl | 350/503 |
| 5,892,617 A | April 1999 | Wallace | 359/353 |
| 6,111,692 A | August 2000 | Sauter | 359/429 |
| 6,172,821 B1 | January 2001 | Isbell et al. | 359/809 |
| 6,992,843 B2 | November 2006 | Juhala | 359/819 |
| 7,142,357 B2 | November 2006 | Greenslade | 359/353 |
| 7,359,114 B2 | April 2008 | Sauter et al. | 359/353 |
| 8,094,309 B1 | January 2012 | Pochapsky | 356/399 |

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Technical Field

The present invention is in the technical field of optical systems. More particularly, the present invention is in the technical field of alignment tools for optical systems.

2. Background Art

Optical devices exist in many different forms and exhibit various operational and physical characteristics suited to their specific purposes. These characteristics may not be shared by other optical devices. Therefore, it is desirable at times to utilize more than one optical device simultaneously in order to realize the combined benefits provided by the devices, and thereby achieve an overall capabilities gain.

For example, a day-vision optical system, referred to hereinafter as “day optic,” may have characteristics such as magnification and a range estimation reticle that are useful to an operator. However, the day optic's capabilities are severely limited when used in low-light conditions. A night-vision optical system, referred to hereinafter as “night optic,” enhances an operator's vision in low-light conditions, but may not possess the magnification and ranging capabilities that the day optic does. By using these dissimilar optical devices together, an operator gains increased usefulness of both systems.

Several approaches exist to achieve the simultaneous use of dissimilar optics. Unfortunately, due to irregular manufacturing techniques, non-uniform design characteristics, etc. between such systems, there often exists an inherent problem of optical path deviation. This results in image misalignment when configuring separate optical devices for tandem use. This problem is common throughout the various approaches used to achieve the benefits of combining dissimilar optical systems.

An integrated approach incorporates structures and methods to provide both day and night capabilities in a single system, such as those described in U.S. Pat. No. 5,892,617, U.S. Pat. No. 6,111,692, and U.S. Pat. No. 6,172,821. This approach results in a complex system of lenses and mirrors to achieve proper image alignment, additional bulk that must be carried even when the night capability is not required, and increased cost to produce, maintain, and repair.

An alternate approach is to temporarily attach a night optic to a mount that suspends the night optic next to or above the day optic, as described in U.S. Pat. No. 4,629,295. A series of mirrors directs the collimated night imagery into the day optic's input aperture. In this arrangement, true imagery alignment must give way to a parallel alignment due to the different mounting heights of the optics.

Tandem-mounted, or in-line, systems maintain the advantages of modularity, low center of gravity, and coaxial optical paths. Image alignment is more easily accomplished when optics are configured in this way.

In this streamlined arrangement, an optical system, referred to hereinafter as “optic #1”, is mounted ahead of another optical system, hereinafter referred to as “optic #2”. Optic #1 is closest to the scene being viewed and the image it produces is projected into optic #2. Optic #2 is considered by the operator to be the primary optic. It produces an image that the operator uses most of the time. Optic #1 is added to the optical path when its imagery characteristics are desired to augment those of optic #2. To be of optimum use to the operator, the images produced by each of the optics must be properly aligned, or overlaid, for display to the operator. The inherent image misalignment, or image shift, must be eliminated or reduced to an acceptable level.

Reducing or eliminating image shift due to alignment error has been achieved in several different ways. One way is to determine the amount of alignment error, and compensate by adjusting the primary optic (optic #2) to be aligned to the image output of optic #1. Unfortunately, this approach is not preferred because the primary optic will no longer be properly aligned to the target line of sight when optic #1 is removed. In some cases, the optical devices may not provide for a means of such adjustment. Another way, then, is to provide mechanical adjustment capability to each of the optics' mounts. This approach is not desirable because realignment needs to be performed every time either of the optics is replaced.

A more efficient approach is to introduce an assembly into the optical path between tandem optics that will provide for image shift correction. U.S. Pat. No. 3,359,849, U.S. Pat. No. 6,992,843, U.S. Pat. No. 7,142,357, U.S. Pat. No. 7,359,114, and U.S. Pat. No. 8,094,309 describe such structures and methods utilizing moveable lenses, rotating Risley prisms, pivotable mirrors, and diverting wedge-prism assemblies positioned within the optical path to redirect the imagery output in another direction. However, these structures and methods are typically incorporated into the housing of specific optical devices, near the output aperture. This limits the number of optical devices that can be used as optic #1 in a tandem configuration.

The prior art methods and structures described in the aforementioned patents introduce and disclose a number of noteworthy advances and technological improvements within the art.

However, they are limited in application, as they are typically integrated into a specific optical device, introduce complexity and performance degradation into the system, add bulk, increase cost, and require the non-intuitive manipulation of multiple assemblies, lenses, prisms, mirrors, etc. to accomplish the desired imagery alignment effect. Additionally, the alignment procedure is typically required to be performed by technicians at the device manufacturer's facilities rather than by the operator in the field.

Accordingly, there is a need in the art for an improved, stand-alone image alignment device which enables the operator to optimize the use of a wider variety of tandem-mounted optical systems.

### BRIEF SUMMARY OF THE INVENTION

An image alignment device for tandem optics (IAD-TO) is disclosed which provides a stand-alone means to optimize the imagery produced by dissimilar tandem-mounted optics. The (IAD-TO) is comprised of an optical alignment element within a sealed housing that is installed between tandem optics through the use of an adaptor arm and mount interface. The optical alignment element not only aligns light rays transmitted from optic #1, it also compensates for field of view differences between the optical devices. The housing includes external adjusting mechanisms which act upon the alignment element, enabling the operator to execute image alignment adjustments on demand. Further attached to the housing is an adaptor arm which accommodates mounting an optical device in front of and in line with the optical alignment element. This arm is exchangeable with other adaptor arms designed to accommodate various optical devices as required. Further attached to the adaptor arm is a quick action mount that interfaces to the mounting surface upon which optic #2 is directly mounted.

The IAD-TO enables and optimizes the use of tandem optics thereby imparting a (retrofit) system capability increase to multiple types of existing optical devices without physically modifying them or replacing them with another device. The increased system capability realized by the operator is the result of combining the performance characteristics of each optical device and enabling them to share capabilities.

The IAD-TO also provides an aftermarket means for injecting data and other source imagery into the optical path, thereby adding new capability to the base optics.

Featuring interchangeable adaptor arms and quick action mount interfaces, the IAD-TO can be used with multiple types of optical devices and can be mounted to a variety of surfaces when needed, and as quickly removed as required by the operator.

The IAD-TO enables the operator to make on-demand image alignment adjustments, especially when using optical devices that provide no such alignment mechanisms.

Other methods and technical features may be readily apparent to one skilled in the art from the following figures and descriptions.

### BRIEF DESCRIPTION OF THE SEVERAL VIEWS OF THE DRAWING

FIG. 1 is a side view of an embodiment of the present invention configured for direct viewing use with a night vision monocular and an optical day scope.

FIG. 2 is a cut-away view of the main housing component of an embodiment of the present invention showing the optical alignment element within.

FIG. 3 is a cross-sectional view of the optical alignment element subcomponent of an embodiment of the present invention.

FIG. 4 is a side view of an embodiment of the present invention configured for use with a telescope and a video camera on a remotely operated platform and using a remote display device.

### DETAILED DESCRIPTION OF THE INVENTION

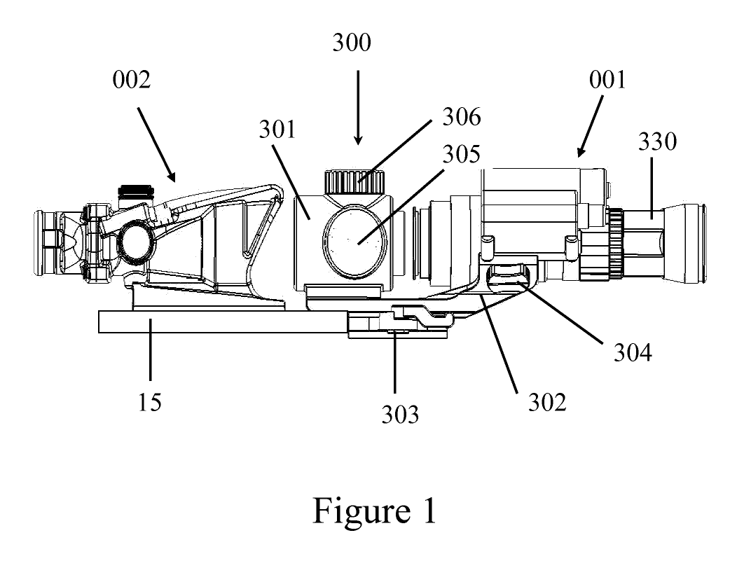

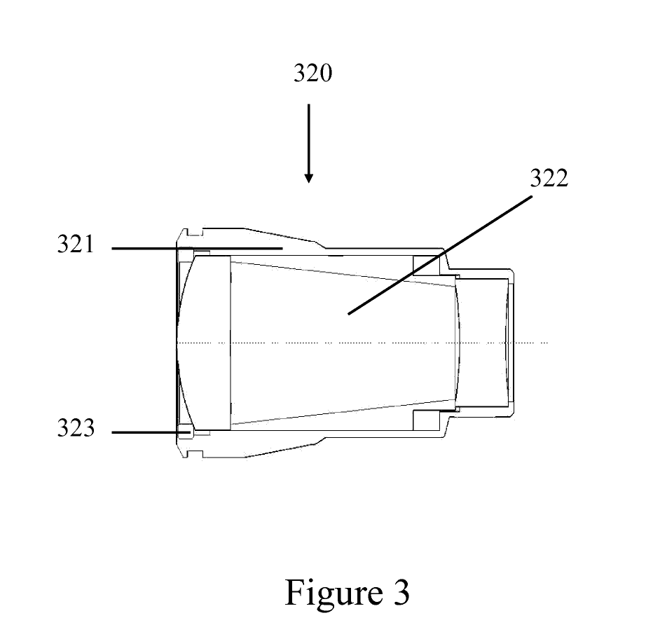

Referring now to the invention in more detail, in FIG. 1 to FIG. 3, there is shown an IAD-TO 300 configured to be used with a night vision optic 001 and a day vision optic 002 for direct viewing.
15 Mounting Surface—Picatinny Rail or other suitable surface upon which the IAD-TO and tandem optics are mounted.
001 Optic #1—The optical device which generates the imagery that is to be aligned with the imagery produced by optic #2.
002 Optic #2—The optical device which produces the base imagery upon which the aligned imagery output from IAD-TO 300 is superimposed.
300 Image Alignment Device for Tandem Optics (IAD-TO)
301 Main Housing of IAD-TO 300.
302 Adaptor Arm—Attached to IAD-TO 300, provides a mounting platform for Optic #1 001
303 Mounting Interface—Attaches IAD-TO 300/Optic #1 001 assembly to the mounting surface 15 upon which Optic #2 002 is separately attached.
304 Attachment Mechanism—Thumbscrew, latch, or similar mechanism that secures Optic #1 001 to adaptor arm 302
305 Protective Caps for external adjustment mechanisms 306
306 External Adjustment Mechanisms—One on top and one on the side of the IAD-TO 300 which provide for lateral and vertical adjustments of the optical alignment element 320.
307 Adjustment Driver—Acts directly upon the optical alignment element 320.
308 Compression Spring—Located between the housing 301 and the adjustable lens tube opposite the corresponding adjustment driver 307.
309 Pivot Gasket—Provides environmental seal and aft pivot surface between housing 301 and optical alignment element 320.
310 Bearing Ring—Provides environmental seal and forward pivot surface between optical alignment element 320 and window cap 311.
311 Window Cap—Forward end of housing 301 through which the optical alignment element
320 accepts imagery to be aligned.
320 Optical Alignment Element
321 Adjustable Lens Tube
322 Foctek Doublet Lens Assembly
323 Lens Retaining Ring
330 Magnification Lens

In more detail, still referring to the invention of FIG. 1 to FIG. 3, An image alignment device for tandem optics (IAD-TO) 300 is disclosed which provides a method and means to optimize the imagery produced by dissimilar tandem-mounted optics 001 & 002. In this arrangement, the imagery output from optic #1 001 is inherently misaligned with the imagery produced by optic #2 002. The IAD-TO 300 allows the operator to correct this image shift so that it coincides more precisely with the desired imagery output from optic #2 002.

The IAD-TO 300 is comprised of an optical alignment element 320 within a sealed housing 301 that is positioned on a common mounting surface 15 between tandem optics 001 & 002 through the use of an adaptor arm 302 and mount interface 303. Attached to the housing 301 is an adaptor arm 302 which provides for mounting an optical device 001 in front of and in line with the optical alignment element 320. The adaptor arm 302 is exchangeable with other adaptor arms designed to accommodate various optical devices as specified. Optical device 001 is secured to the adaptor arm 302 by a thumbscrew, latch, or similar mechanism 304. Further attached to the underside of the adaptor arm 302 is a quick action mount 303 which interfaces to the mounting surface 15 upon which optic 002 is separately mounted. The IAD-TO 300/optic #1 001 assembly is attached to the mounting surface 15 in front of optic #2 002.

The housing 301 includes two external adjusting mechanisms 306, one on top and one on the side, which act upon the alignment element 320, enabling the operator to execute image alignment adjustments on demand. Protective caps 305 cover the external adjusting mechanisms 306 and prevent inadvertent adjustment, physical damage, and environmental degradation to the adjustment mechanisms 306. The adjustment mechanisms 306 actuate the adjustment drivers 307 which are in contact with the adjustable lens tube 321 of the optical alignment element 320. In concert with opposing compression springs 308, located between the housing 301 and the adjustable lens tube, the adjustment drivers 307 control lateral and vertical movement of the optical alignment element 320. A pivot gasket 309 and bearing ring 310 provide pivot surfaces and environmental seals for the ends of the optical alignment element 320 as well as manage fore and aft movement within the housing 301.

The optical alignment element 320 is comprised of a Foctek doublet lens assembly with spacer 322 fixed within an adjustable lens tube 321 by a retaining ring 323. As an option, this same assembly may be used separately as an afocal magnifier lens installed on the objective lens of various optics. The imagery output of optic #1 001 is received by the optical alignment element 320 through the window cap 311 at the forward end of the housing 301. By adjusting the orientation of the optical alignment element 320 within the housing 301, the optical path is altered so that the imagery output from the IAD-TO 300 is properly aligned with the optical path of optic #2 002. Once this alignment has been achieved, the IAD-TO 300/optic #1 001 assembly may be removed from the mounting surface 15 and reinstalled as needed without requiring further alignment.

In further detail, still referring to the invention of FIG. 1 to FIG. 3, when dissimilar optical devices are arranged in tandem, an inherent optical misalignment of 1-15′ of arc occurs due to manufacturing differences between the optics. The IAD-TO 300 enables the operator to correct for up to 35 minutes of angle (MOA) in any direction from center in 0.5 MOA increments. Lateral and vertical movements of the optical alignment element 320 are controlled by AZ/EL adjustment drives 307 and their corresponding springs 308 acting on the opposite side of the optical alignment element 320 from each adjuster 307. A bearing ring 310 and pivot gasket 309 control movement of the fore and aft surfaces of the optical alignment element 320 within the main housing 301, and assist in providing adjustment retention.

Each movement of the optical alignment element 320 results in a corresponding deviation of the optical path, allowing the operator to “steer” the imagery output of optic #1 001 as necessary so that it precisely aligns with the imagery produced by optic #2 002.

The most efficient mounting arrangement is one that has all 3 devices at a common optical axis height above the mounting surface 15, in this case approximately 40 mm. The adaptor arm 302 can be exchanged easily with adaptor arms designed for specific applications of different heights and/or optical devices.

The optical alignment element 320 not only aligns light rays transmitted from optic #1 001, it also compensates for field of view differences between the optical devices 001 & 002. The Foctek doublet lens assembly 322 within the optical alignment element 320 is specifically sized to convert optic #1 001 output to match the normal field of view (FOV) of optic #2 002, in this case converting 40 degree FOV to 9 degrees. This is accomplished through the matching of a Foctek doublet lens assembly 322 with an appropriate length spacer. The sizes of the lenses and spacer lengths will affect the magnification and FOV ratios, providing for design flexibility to accommodate multiple types of dissimilar optical devices.

An additional optical alignment element 320 subcomponent (magnification lens 330) can be used on optic #1 001 objective lens to magnify the scene and restore a 1:1 magnification ratio of the optic #1 001/IAD-TO 300 combination. This means the scene as viewed through optic #2 002 will have the same FOV and magnification as it does with or without optic #1 001/IAD-TO 300 assembly installed in front of optic #2 002. As an option, an optical alignment element 320 subcomponent may be used separately as an afocal magnifier lens 330 installed on the objective lens of various optics to increase their useful operating range.

The construction details of the invention as shown in FIG. 1 to FIG. 3 are that the IAD-TO 300 is constructed of lightweight materials, and that the materials are very durable against physical and environmental stressors such as direct impact, atmospheric pressure, extreme temperature, etc.

The main external components may be made of aluminum (with a scratch resistant anodized coating applied), injection molded plastic (with glass or carbon fiber reinforcement), or other sufficiently rigid and strong material. These include the main housing 301, protective caps 305, adaptor arm 302, mount interface 303, attachment mechanism 304, window cap 311, adjustable lens tube 321, and lens retaining ring 323.

The lens assembly 322 is optical glass that is specially hard carbon coated to provide scratch resistance and optimize low light performance. High strength plastic or other compounds suitable as replacements for optical glass may be used.

Other hardware such as retaining screws, compression springs 308, and adjuster drivers 307 is made from metals such as stainless steel, aluminum, and titanium.

Flexible seals are made of neoprene rubber, silicon, or other suitable material to prevent environmental effects penetrating the housing 301.

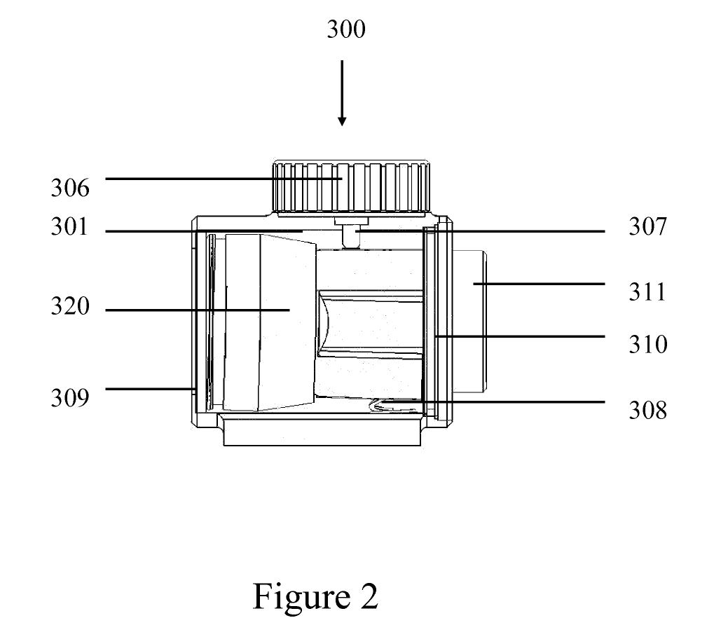

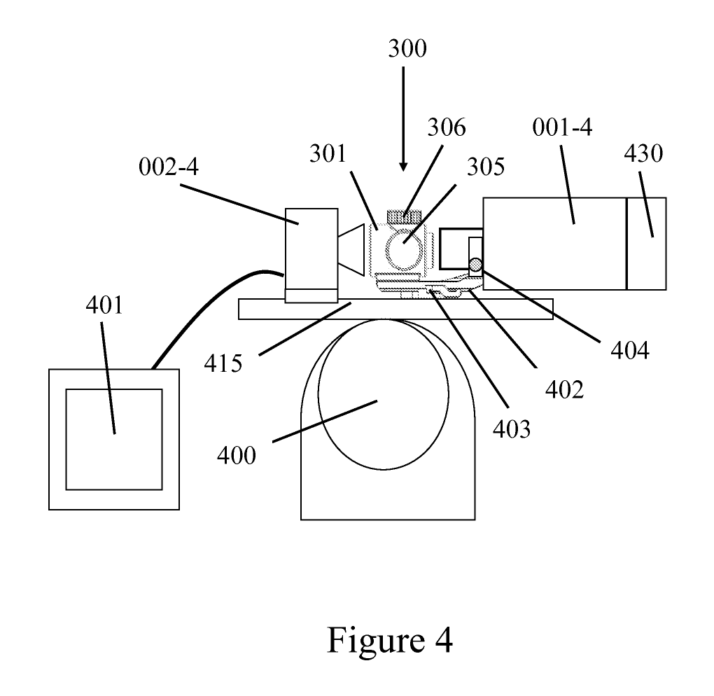

Referring now to the invention in more detail, in FIG. 2 to FIG. 4, there is shown an IAD-TO 300 configured to be used with an optical telescope (optic #1) 001-4 and a digital video camera (optic #2) 002-4 mounted on a remotely operated positioning apparatus 400. The combined imagery is transmitted to a remote display device 401 for viewing by the operator.
001-4 Optic #1—(Optical Telescope) generates the imagery that is to be aligned with the imagery produced by optic #2.
002-4 Optic #2—(Video Camera) produces the base imagery upon which the aligned imagery output from IAD-TO 300 is superimposed.
300 Image Alignment Device for Tandem Optics (IAD-TO)
301 Main Housing of IAD-TO 300
305 Protective Caps for external adjustment mechanisms 306
306 External Adjustment Mechanisms—One on top and one on the side of the IAD-TO 300 which provide for lateral and vertical adjustments of the optical alignment element 320.
307 Adjustment Driver—Acts directly upon the optical alignment element 320.
308 Compression Spring—Located between the housing 301 and the adjustable lens tube opposite the corresponding adjustment driver 307.
309 Pivot Gasket—Provides environmental seal and aft pivot surface between housing 301 and optical alignment element 320.
310 Bearing Ring—Provides environmental seal and forward pivot surface between optical alignment element 320 and window cap 311.
311 Window Cap—Forward end of housing 301 through which the optical alignment element 320 accepts imagery to be aligned.
320 Optical Alignment Element
321 Adjustable Lens Tube
322 Foctek Doublet Lens Assembly
323 Lens Retaining Ring
400 Remotely Operated Positioning Apparatus
401 Remote Display
402 Adaptor Arm to mount Telescope
403 Mount Interface for Tilt & Pan platform
404 Attachment Mechanism—Optic #1 001-4 to adaptor arm 402
415 Mounting Surface—Platform, Tilt & Pan
430 Magnification Lens

In more detail, still referring to the invention of FIG. 2-FIG. 4, in this embodiment, the IAD-TO 300 is used with optic #2 002-4 to retrofit alignment and video capture capabilities to optic #1 001-4 that was originally manufactured without them.

The IAD-TO 300 is coupled with optic #1 001-4 by means of the adaptor arm 402 with attachment mechanism 404. Attached to the underside of the adaptor arm is the mount 403 which interfaces with the tilt & pan platform 415 upon which optic #2 is separately attached. When initially configured this way, the imagery output from optic #1 001 is inherently misaligned with the imagery produced by optic #2 002. The IAD-TO 300 allows the operator to correct this image shift so that it precisely overlays the desired imagery output from optic #2 002. The operator manipulates the external adjustment mechanisms 306 of the IAD-TO 300 to align the imagery output from Optic #1 001-4 to that of Optic #2 002-4. The combined imagery is then sent to the remote display 401 for viewing by the operator.

The IAD-TO 300 is comprised of an optical alignment element 320 within a sealed housing 301 that is positioned on a common mounting surface 415 between tandem optics 001-4 & 002-4 through the use of an adaptor arm 402 and mount interface 403. Attached to the housing 301 is an adaptor arm 402 which provides for mounting an optical device 001-4 in front of and in line with the optical alignment element 320. The adaptor arm 402 is exchangeable with other adaptor arms designed to accommodate various optical devices as specified. Optical device 001-4 is secured to the adaptor arm 402 by a thumbscrew, latch, clamp or similar attachment mechanism 404. Further attached to the underside of the adaptor arm 402 is a quick action mount 403 which interfaces to the mounting surface 415 upon which optic #2 002-4 is separately mounted. The IAD-TO 300/optic #1 001-4 assembly is attached to the mounting surface 415 in front of optic #2 002-4.

The housing 301 includes two external adjusting mechanisms 306, one on top and one on the side, which act upon the alignment element 320, enabling the operator to execute image alignment adjustments on demand. Protective caps 305 cover the external adjusting mechanisms 306 and prevent inadvertent adjustment, physical damage, and environmental degradation to the adjustment mechanisms 306. The adjustment mechanisms 306 actuate the adjustment drivers 307 which are in contact with the adjustable lens tube 321 of the optical alignment element 320. In concert with opposing compression springs 308, located between the housing 301 and the adjustable lens tube, the adjustment drivers 307 control lateral and vertical movement of the optical alignment element 320. A pivot gasket 309 and bearing ring 310 provide pivot surfaces and environmental seals for the ends of the optical alignment element 320 as well as manage fore and aft movement within the housing 301.

The optical alignment element 320 is comprised of a Foctek doublet lens assembly with spacer 322 fixed within an adjustable lens tube 321 by a retaining ring 323. As an option, this same assembly may be used separately as an afocal magnifier lens installed on the objective lens of various optics. The imagery output of optic #1 001-4 is received by the optical alignment element 320 through the window cap 311 at the forward end of the housing 301. By adjusting the orientation of the optical alignment element 320 within the housing 301, the optical path is altered so that the imagery output from the IAD-TO 300 is properly aligned with the optical path of optic #2 002-4. Once this alignment has been achieved, the IAD-TO 300/optic #1 001-4 assembly may be removed from the mounting surface 415 and reinstalled as needed without requiring further alignment.

In further detail, still referring to the invention of FIG. 2 to FIG. 4, when dissimilar optical devices are arranged in tandem, an inherent optical misalignment of 1-15′ of arc occurs due to manufacturing differences between the optics. The IAD-TO 300 enables the operator to correct for up to 35 minutes of angle (MOA) in any direction from center in 0.5 MOA increments. Lateral and vertical movements of the optical alignment element 320 are controlled by AZ/EL adjustment drives 307 and their corresponding springs 308 acting on the opposite side of the optical alignment element 320 from each adjuster 307. A Ring bearing ring 310 and pivot gasket 309 control movement of the fore and aft surfaces of the optical alignment element 320 within the main housing 301, and assist in providing adjustment retention.

Each movement of the optical alignment element 320 results in a corresponding deviation of the optical path, allowing the operator to “steer” the imagery output of optic #1 001-4 as necessary so that it precisely aligns with the imagery produced by optic #2 002-4.

The most efficient mounting arrangement is one that has all 3 devices at a common optical axis height above the mounting surface 415, in this case approximately 40 mm. The adaptor arm 402 can be exchanged easily with adaptor arms designed for specific applications of different heights and/or optical devices.

The optical alignment element 320 not only aligns light rays transmitted from optic #1 001-4, it also compensates for field of view (FOV) differences between the optical devices 001-4 & 002-4 and optimizes the analog imagery in preparation for digital conversion. The Foctek doublet lens assembly 322 within the optical alignment element 320 is specifically sized to convert optic #1 001-4 output to match the normal FOV of optic #2 002-4. This is accomplished through the matching of a Foctek doublet lens assembly 322 with appropriate length spacer. The sizes of the lenses and spacer lengths directly affect the magnification and FOV ratios, providing for design flexibility to accommodate multiple types of dissimilar optical devices.

An additional magnification lens 430 can be used on optic #1 001-4 objective lens to magnify the scene and restore a 1:1 magnification ratio of the optic #1-4/IAD-TO 300 combination. This means the scene as viewed through optic #2 002-4 will have the same FOV and magnification as it does with or without optic #1 001-4/IAD-TO 300 assembly installed in front of optic #2 002-4.

The construction details of the invention as shown in FIG. 2 to FIG. 4 are that the IAD-TO 300 is constructed of lightweight materials, and that the materials are very durable against physical and environmental stressors such as direct impact, atmospheric pressure, extreme temperature, etc. The main external components may be made of aluminum (with a scratch resistant anodized coating applied), injection molded plastic (with glass or carbon fiber reinforcement), or other sufficiently rigid and strong material. These include the main housing 301, protective caps 305, adaptor arm 402, mount interface 403, attachment mechanism 404, window cap 311, adjustable lens tube 321, and lens retaining ring 323.

The lens assembly 322 is optical glass, specially hard carbon coated to provide scratch resistance and optimize low light performance. High strength plastic or other compounds suitable as replacements for optical glass may be used.

Other hardware such as retaining screws, compression springs 308, and adjuster drivers 307 is made from metals such as stainless steel, aluminum, and titanium.

Flexible seals are made of neoprene rubber, silicon, or other suitable material to prevent environmental effects penetrating the housing.

The advantages of the present invention include, without limitation, that it provides a retrofit capability increase to existing products. It provides a pathway to inject data and other source imagery into the optical stream, thereby enabling new capabilities to be added to both optical devices. It enables the operator to make alignment adjustments as needed without having to involve technicians or send the device back to the manufacturer. It provides a means and method of alignment for those devices where no such provision exists. It is easily adaptable to many different types of devices. It is a modular approach which yields an easy to remove/replace component that does not degrade the original operating capabilities of either of the other optical devices. It is a simple design for low cost and ease of manufacture and maintenance. It is a low cost investment for improving items—not a high cost replacement product.

In broad embodiment, the invention is an improved image alignment device for optimizing the use of tandem-mounted optical systems.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. An apparatus that is positioned between optical devices that are configured in tandem and is used to align the imagery output of both devices to coincide. The Imagery Alignment Device for Tandem Optics (IAD-TO) consists of:
A manually adjustable alignment element within a sealed housing;
An adaptor mounting arm upon which an optical device (optic #1) is attached and held in a fixed position in front of the IAD-TO housing which is affixed to the other end of the arm;
A mounting interface which is attached to the underside of the adaptor arm and is used to attach the assembly to the mounting surface in front of the primary optic (optic #2);
A separate magnification lens assembly that is attachable to the objective lens housing of optic #1.

2. The apparatus of claim 1, wherein the alignment element is a Foctek doublet lens assembly.

3. The apparatus of claim 1, wherein the adjustment mechanism knobs used for lateral and vertical positioning of the alignment element are external to the housing for ease of access and have protective caps to prevent inadvertent movement.

4. The apparatus of claim 1, wherein the adaptor mounting arm has a quick action attachment mechanism for easy installation and removal of the optical device as desired.

5. The apparatus of claim 1, wherein the adaptor mounting arm is interchangeable with other adaptor arms configured for use with different optics.

6. The apparatus of claim 1, wherein the mounting interface has a quick action attachment mechanism for easy installation and removal of the optic #1/IAD-TO assembly from the mounting surface in front of optic #2 as desired.

7. The apparatus of claim 1, wherein the mounting interface is interchangeable with other mounting interfaces configured for use with different mounting surfaces.

8. The apparatus of claim 1, wherein the separate magnification lens assembly is afocal.

9. The apparatus of claim 1, wherein the separate magnification lens assembly has interchangeable threaded collars and throw lever clamping mount adaptor to secure it to a variety of optical devices' objective lens housings.

10. The method for adjusting the imagery output of an optical device (optic #1) so that its optical path coincides with that of another optical device (optic #2), considered to be the primary device, when they are mounted in tandem, including the steps of:
Providing a manually adjustable alignment element within a separate sealed housing;
Providing a means to secure an optical device in a fixed position in front of the imagery alignment device;
Providing a means to easily install and remove the optic #1/IAD-TO assembly from in front of optic #2 as desired;
Providing a means to preserve the normal field of view and magnification level of the adjusted imagery output of the IAD-TO for use by optic #2.

11. The method of claim 10, wherein the IAD-TO is not incorporated into the design of any specific optical device, but is modular in design and can be used in many combinations of different optical devices when they are configured in tandem.

12. The method of claim 10, wherein the ability to adjust imagery output is imparted to optical devices not originally provided such a capability.

13. The method of claim 10, wherein the operator is provided a means to perform imagery alignment on demand.

14. The method of claim 11, wherein the adaptor mounting arm is interchangeable to facilitate interoperability with various optical devices.

15. The method of claim 10, wherein the adaptor mounting arm provides a releasable attachment mechanism for the optical device so that it can be easily installed and removed as desired.

16. The method of claim 10, wherein the mounting interface is interchangeable to facilitate interoperability with various mounting surfaces and platforms.

17. The method of claim 10, wherein the mounting interface provides a releasable attachment mechanism for the optic #1/IAD-TO assembly so that it can be easily installed and removed from in front of optic #2 as desired.
